(19) United States
(12) Patent Application Publication
(10) Pub. No.: US 2022/0185413 A1
(43) Pub. Date: Jun. 16, 2022

(54) DECORATIVE ACCESSORY SYSTEM FOR SCOOTERS, BICYCLES, AND THE LIKE

(71) Applicant: WHEELY BANDS, LLC, MIDLOTHIAN, VA (US)

(72) Inventor: DEBORAH ZOOK, MIDLOTHIAN, VA (US)

(21) Appl. No.: 17/543,393

(22) Filed: Dec. 6, 2021

Related U.S. Application Data
(60) Provisional application No. 63/123,785, filed on Dec. 10, 2020.

(51) Int. Cl. B62J 50/40

(52) U.S. Cl. CPC B62J 50/40

(57) ABSTRACT

A decorative accessory system comprises first, second, and third decorative accessory devices. Each device comprises a rigid main body having a T-handle or hook and a ferrous plate or magnet, a flexible sleeve defining a chamber, and a decorative element having a magnet or a ferrous plate. The main body is selectively at least partially insertable into the chamber such that the T-handle or hook protrudes through a first sleeve opening and such that the ferrous plate or magnet of the main body is aligned with a second sleeve opening. The decorative element is selectively attachable to the main body by contacting the magnet or ferrous plate of the decorative element to the ferrous plate or magnet of the main body.

### CROSS-REFERENCE TO RELATED APPLICATIONS

This application claims priority to pending U.S. Provisional Application Ser. No. 63/123,785, filed Dec. 10, 2020, the contents of which are incorporated herein by reference in its entirety.

### FIELD OF THE INVENTION

The present invention relates to decorative accessories that may be attached to scooters, bicycles, and the like.

### BACKGROUND OF THE DISCLOSURE

Riders of scooters and bicycles, especially children, often like to attach accessories to their scooters or bicycles. Such accessories are often simply decorative, rather than functional. In addition to being fun and colorful, it is preferable that such decorative accessories be durable and easy to attach and remove.

### BRIEF SUMMARY OF THE DISCLOSURE

In one embodiment of the invention, a decorative accessory system comprises a first decorative accessory device. The first decorative accessory device comprises a rigid main body, a flexible sleeve, and a decorative element. The rigid main body has a first side from which a T-handle or a hook extends and second side to which a ferrous plate or magnet is affixed. The second side of the main body is adjacent to the first side of the main body. The flexible sleeve defines a chamber. The sleeve has a first side defining a first opening, a second side defining a second opening, and a third side from which an attachment loop extends. The second side of the sleeve is adjacent to both the first side and the third side of the sleeve, and the third side of the sleeve is opposite the first side of the sleeve. The decorative element has a first side to which a magnet or a ferrous plate is affixed. The main body is selectively at least partially insertable into the chamber such that the T-handle or hook protrudes through the first opening and such that the ferrous plate or magnet of the main body is aligned with the second opening. The decorative element is selectively attachable to the main body by contacting the magnet or ferrous plate of the decorative element to the ferrous plate or magnet of the main body.

The sleeve may have a fourth side defining a third opening through which the main body is selectively at least partially insertable into the chamber. The fourth side is opposite the second side of the sleeve and adjacent to both the first side and the third side of the sleeve.

The system may further comprise a flexible band that is selectively attachable to both the T-handle or hook of the main body and to the attachment loop of the sleeve when the main body is at least partially inserted into the chamber. The flexible band may be adapted to be selectively (1) attached to the attachment loop of the sleeve, (2) wrapped around an object, and (3) selectively attached to the T-handle or hook of the main body such that the main body and sleeve are secured to the object.

The decorative element may comprise a T-handle or hook extending from an edge of the decorative element. The sleeve may have a flexible flange adjacent to the second opening, the flange defining a flange hole. The T-handle or hook of the decorative element may be selectively engageable with the flange hole to retain the decorative element to the main body and sleeve.

The decorative element may have a second side opposite the first side and a decorative indicium (or indicia) attached to the second side.

The decorative element may have a second side opposite the first side, an axle protruding from the second side, and a free-spinning propellor mounted to the axle.

The system may further comprise a second decorative accessory device, identical to the first decorative accessory device. The second decorative accessory device may be selectively attachable to the first decorative accessory device by engaging the T-handle or hook of the main body of the first decorative accessory device to the attachment loop of the sleeve of the second decorative accessory device and engaging the T-handle or hook of the main body of the second decorative accessory device to the attachment loop of the sleeve of the first decorative accessory device.

The system may further comprise a third decorative accessory device, identical to the first decorative accessory device. The first, second, and third decorative accessory devices are selectively attachable in a ring by (a) engaging the T-handle or hook of the main body of the first decorative accessory device to the attachment loop of the sleeve of the second decorative accessory device, (b) engaging the T-handle or hook of the main body of the second decorative accessory device to the attachment loop of the sleeve of the third decorative accessory device, and (c) engaging the T-handle or hook of the main body of the third decorative accessory device to the attachment loop of the sleeve of the first decorative accessory device. Prior to engaging the T-handle or hook of the main body of the third decorative accessory device to the attachment loop of the sleeve of the first decorative accessory device, the first, second, and third decorative accessory devices are adapted to be selectively wrapped around an object such that the first, second, and third decorative accessory devices are secured to the object when the T-handle or hook of the main body of the third decorative accessory device is engaged to the attachment loop of the sleeve of the first decorative accessory device.

Alternative embodiments of the invention comprise methods for attaching decorative accessory devices to an object.

### BRIEF DESCRIPTION OF THE SEVERAL VIEWS OF THE DRAWINGS

Reference will now be made to the accompanying drawings, which are not necessarily drawn to scale. The following detailed description of the disclosure will be better understood when read in conjunction with the appended drawings. It should be understood, however, that the disclosure is not limited to the precise arrangements and instrumentalities shown. In the drawings:

FIG. 1 is a front view photograph of three linked decorative accessory systems for scooters, bicycles, and the like, in accordance with embodiments of the present invention.

FIG. 2 is a front view of the decorative accessory systems of FIG. 1, unlinked and in differing states of assembly.

FIG. 3 is a front view of one of the linked decorative accessory systems of FIG. 1 attached to a connection band.

FIG. 4 is a perspective view of several decorative accessory systems for scooters, bicycles, and the like affixed to a scooter post, in accordance with embodiments of the present invention.

FIG. 5 is a perspective view from the front, top, and left of an external sleeve of a decorative accessory system for scooters, bicycles, and the like, in accordance with embodiments of the present invention.

FIG. 6 is a perspective view from the front, top, and right of the external sleeve of FIG. 5.

FIG. 7 is a perspective view from the rear, bottom, and right of the external sleeve of FIG. 5.

FIG. 8 is a perspective view from the front, top, and left of an internal base of a decorative accessory system for scooters, bicycles, and the like, in accordance with embodiments of the present invention.

FIG. 9 is a perspective view from the front, top, and left of a base for a decorative propeller of a decorative accessory system for scooters, bicycles, and the like, in accordance with embodiments of the present invention.

FIG. 10 is a perspective view from the front, top, and right of a decorative propeller of a decorative accessory system for scooters, bicycles, and the like, in accordance with embodiments of the present invention.

FIG. 11 is a perspective view from the rear, top, and right of the decorative propeller of FIG. 10.

FIG. 12 is a perspective view from the front, top, and left of a base for a decorative element of a decorative accessory system for scooters, bicycles, and the like, in accordance with embodiments of the present invention.

### DETAILED DESCRIPTION OF THE DISCLOSURE

Certain terminology is used in the following description for convenience only and is not limiting. The words “lower,” “bottom,” “upper,” and “top” designate directions in the drawings to which reference is made. The words “inwardly,” “outwardly,” “upwardly” and “downwardly” refer to directions toward and away from, respectively, the geometric center of the device, and designated parts thereof, in accordance with the present disclosure. Unless specifically set forth herein, the terms “a,” “an” and “the” are not limited to one element, but instead should be read as meaning “at least one.” The terminology includes the words noted above, derivatives thereof and words of similar import.

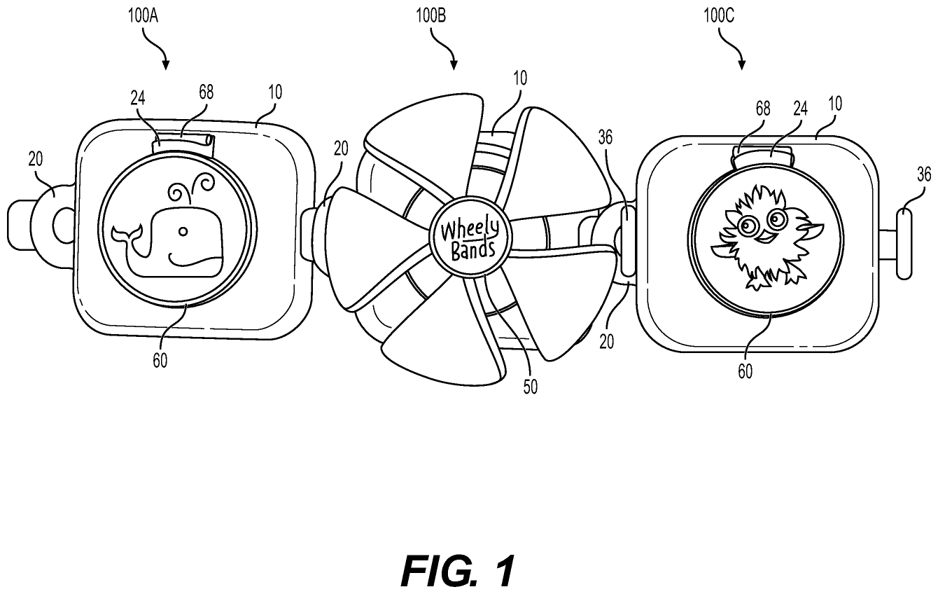

Embodiments of the invention are directed to a decorative accessory system for scooters, bicycles, and the like. The decorative accessory system of embodiments of the invention is designed to allow a user to temporarily affix a decorative element to an elongated tubular structure, such as the handlebar post of a scooter or a bicycle. The decorative accessory system of embodiments of the invention is modular in that different base components of different colors may be matched with a variety of different decorative elements having different colors and/or different structures. FIG. 1 shows three different combinations of elements. Systems 100A and 100C have different decorative images as the decorative element, while the decorative element of system 100B is a free-spinning propeller blade.

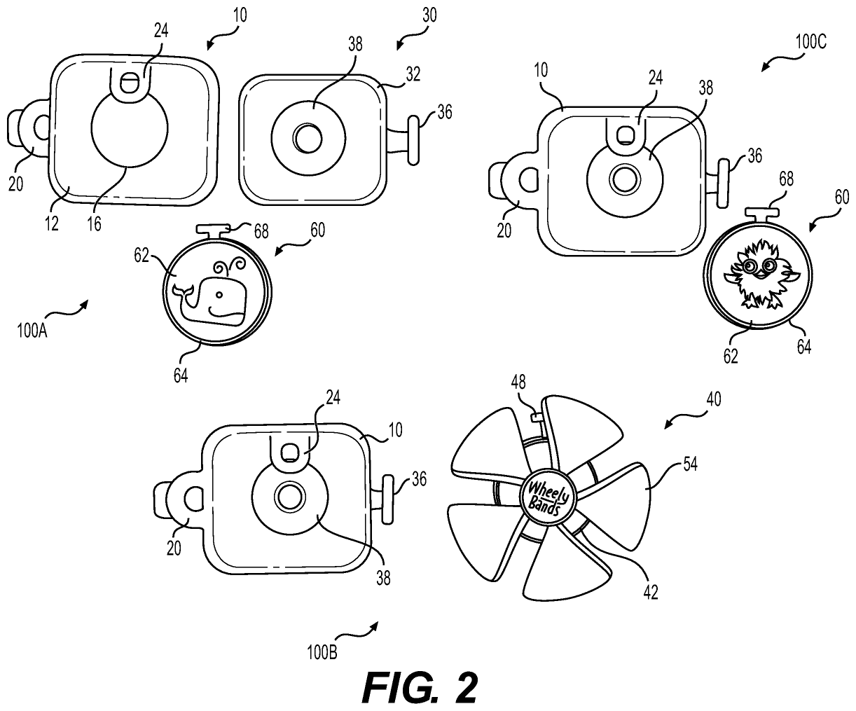

FIG. 2 shows the systems of FIG. 1 in various states of disassembly. (The assembled/disassembled states shown and described herein are based on the assembly and disassembly that will typically be performed by a user of the systems, and not based on the assembly and disassembly of manufacturing-level components.) In FIG. 2, system 100A is fully disassembled into the external sleeve 10, the internal base 30, and the decorative image attachment 60. System 100B is partially disassembled in that the internal base (of which only the magnetic attachment portion 38 is visible) is enclosed by the external sleeve 10, while the decorative propeller blade 40 is separated from the internal base and external sleeve. Similarly, system 100C is partially disassembled in that the internal base (of which only the magnetic attachment portion 38 is visible) is enclosed by the external sleeve 10, while the decorative image attachment 60 is separated from the internal base and external sleeve. These components are described in further detail below.

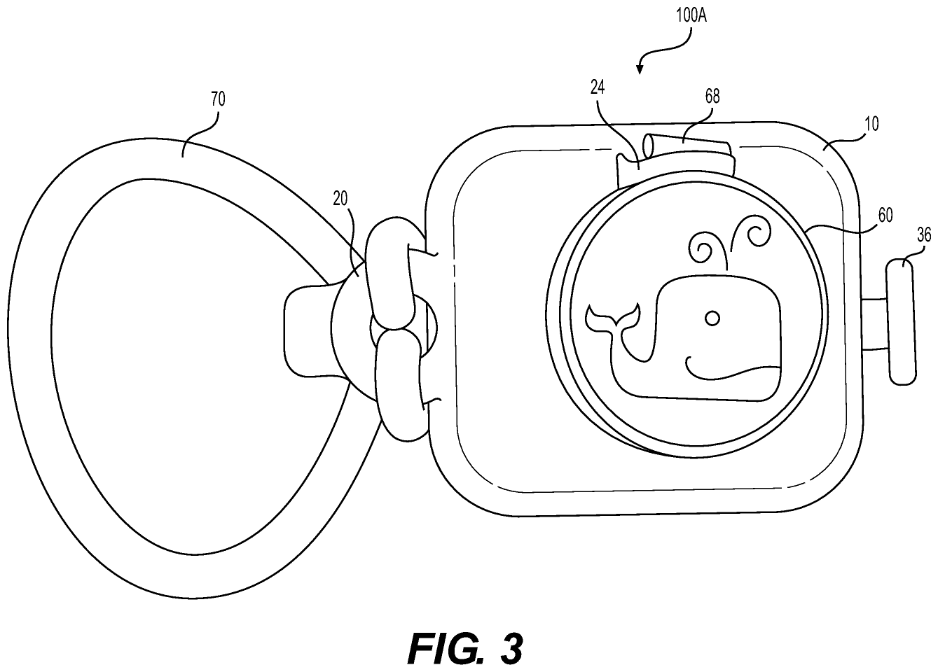

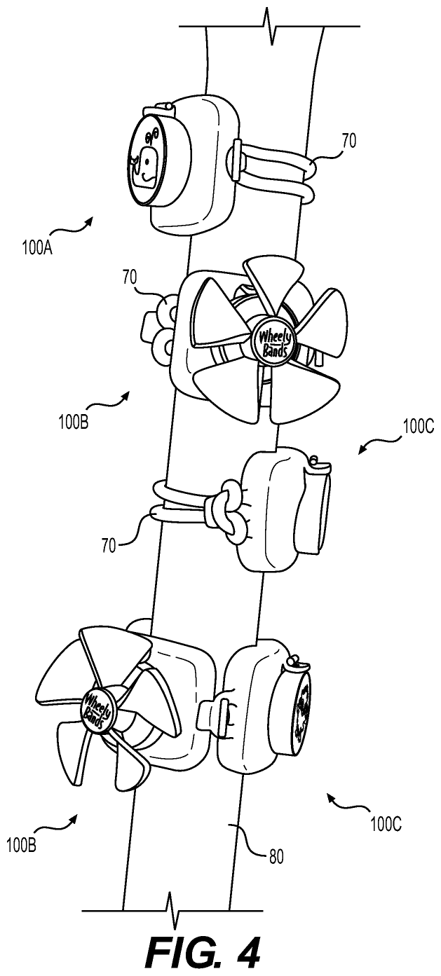

FIG. 3 shows the system 100A fully assembled and attached to an attachment band 70. The attachment band 70 may be used to attach a single system to a handlebar post, as described further below. FIG. 4 shows three systems 100A, 100B, and 100C attached individually to a handlebar post 80 using an attachment band 70, and three systems (bottom), two of which are visible, attached to each other in a ring and encircling the handlebar post 80.

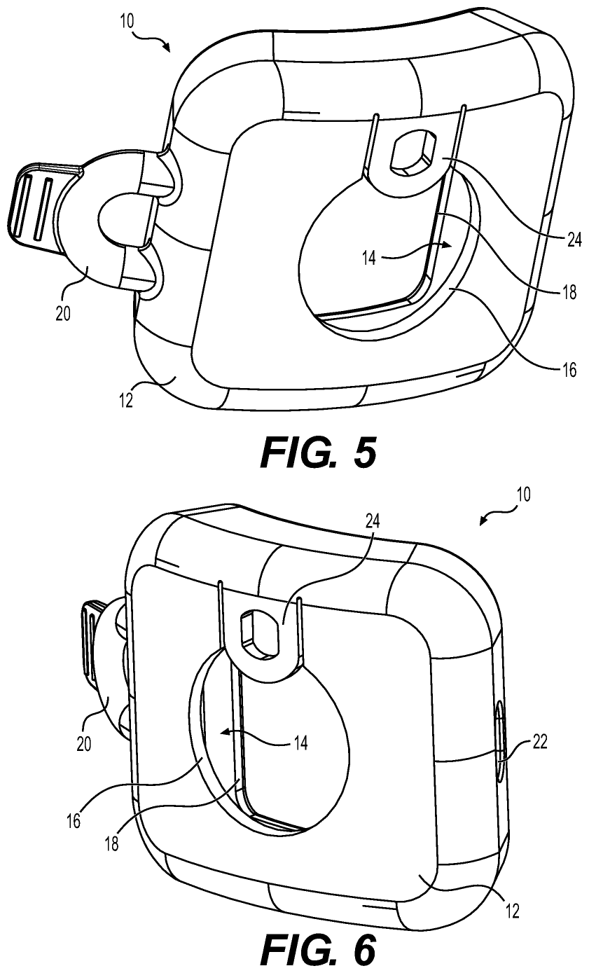

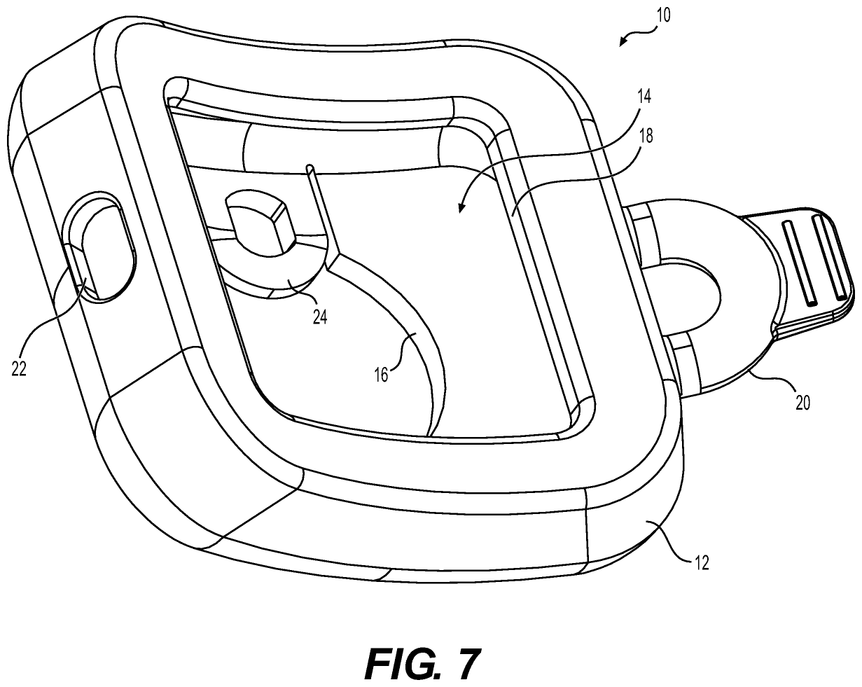

FIGS. 5-12 illustrate details of the individual components of a decorative accessory system for scooters, bicycles, and the like, in accordance with embodiments of the invention. FIGS. 5-7 illustrate the external sleeve 10. The external sleeve 10 covers and protects the internal base 30, provides attractive color options, enables access to the connection point between the internal base 30 and the decorative attachment 40 or 60 (for example), and provides one part of the attachment mechanism to attach two or more systems to each other or to attach an attachment band 70. The sleeve 10 is constructed of any suitable strong, durable, and flexible material, such as silicone rubber. The sleeve 10 comprises a main body 12 that defines an internal chamber 14. The main body 12 has somewhat the shape of a rectangular prism, but slightly curved to better conform to the curvature of a handlebar post. A front access hole 16 is defined in the front wall of the main body 12 to provide access to the attachment portion of the internal base 30. A rear insertion hole 18 is defined in the rear wall of the main body 12 to enable insertion of the internal base 30 into the external sleeve 10. A flexible flange 24 with a hole defined therein is adjacent the front access hole 16 to provide a second means of attachment of the decorative attachment for additional security. An attachment loop 20 extends from one side wall of the main body 12, while an attachment hole 22 is defined in an opposite side wall.

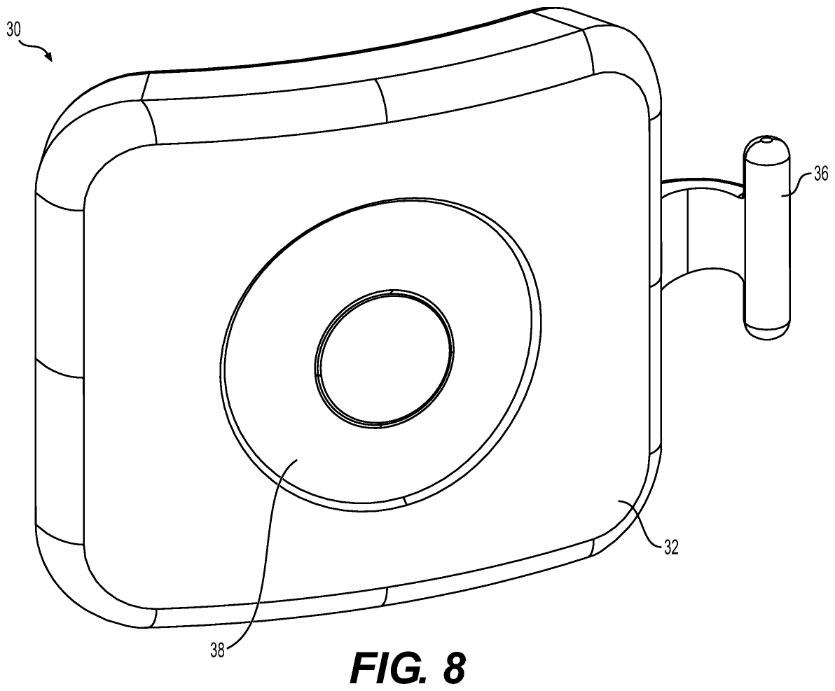

FIG. 8 illustrates the internal base 30. The internal base 30 has a main body 32, an attachment point 38 for a decorative attachment 40 or 60 (for example) on the front surface. The attachment point 38 may be a magnet or (more likely) a ferrous plate that cooperates with a corresponding ferrous plate or magnet on the rear surface of the decorative attachment (or any other suitable attachment mechanism that cooperates with a corresponding attachment mechanism on the back side of a decorative attachment), and a generally curved T-shaped attachment handle 36 projecting from one side wall. The internal base 30 is constructed of any suitable strong, durable, and rigid material, such as any suitable plastic. The internal base 30 has somewhat the shape of a rectangular prism, but curved to match the curvature of the external sleeve 10 to better conform to the curvature of a handlebar post.

The internal base 30 provides the surface to which any desired decorative attachment is attached. The internal base 30 is inserted into an external sleeve 10 having a desired color (or other desired decorative feature). To insert an internal base 30 into an external sleeve, the attachment handle 36 and corresponding side of the internal base 30 is inserted through the rear insertion hole 18 into the internal chamber 14 of the external sleeve 10, and the attachment handle is pushed through the side attachment hole 22, until that side of the internal base 30 is seated into the corresponding side of the internal chamber 14. The rest of the internal base 30 is inserted through the rear insertion hole 18 into the internal chamber 14, which may require some pulling/stretching of the perimeter of the rear insertion hole 18, until the internal base 30 is fully inserted and seated into the external sleeve 10. At this point, the magnet or ferrous plate 38 is aligned with and visible through the front access hole 16.

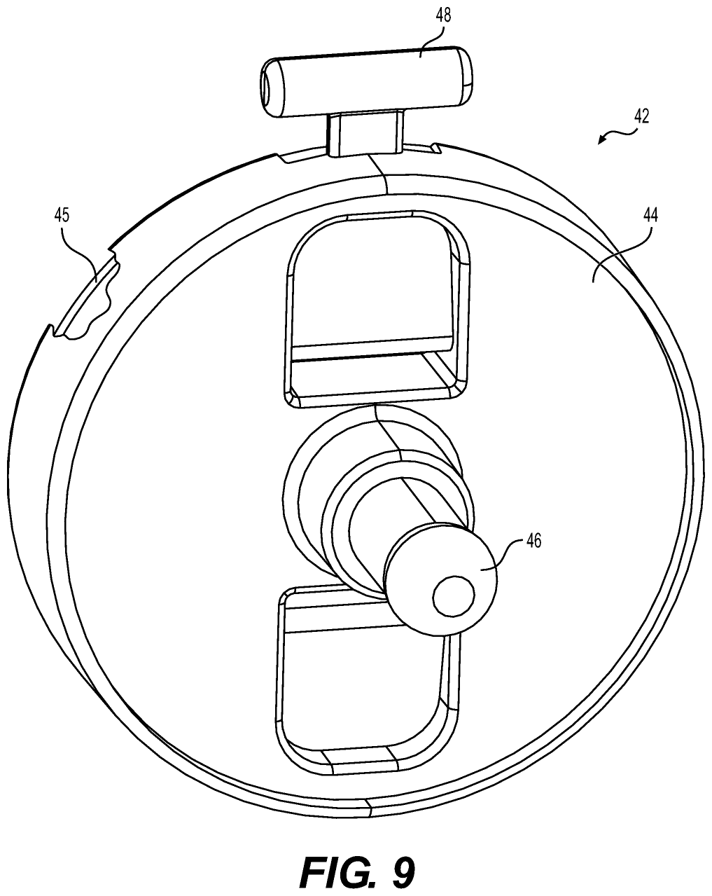

FIGS. 9-11 illustrate the components that comprise the free-spinning propeller decorative attachment 40. FIG. 9 illustrates a base portion 42, having a generally disc-shaped main body 44, a post 46 projecting forward from the main body 44, and a T-shaped attachment handle 48 projecting upward from the main body 44. Part of the edge rim of the main body 44 is cut away to illustrate that a ferrous plate or (more likely) a magnet 45 is affixed to the rear side of the main body 44 (opposite the post 46) to selectively attach the decorative attachment 40 to the magnet or ferrous plate 38 of the internal base 30.

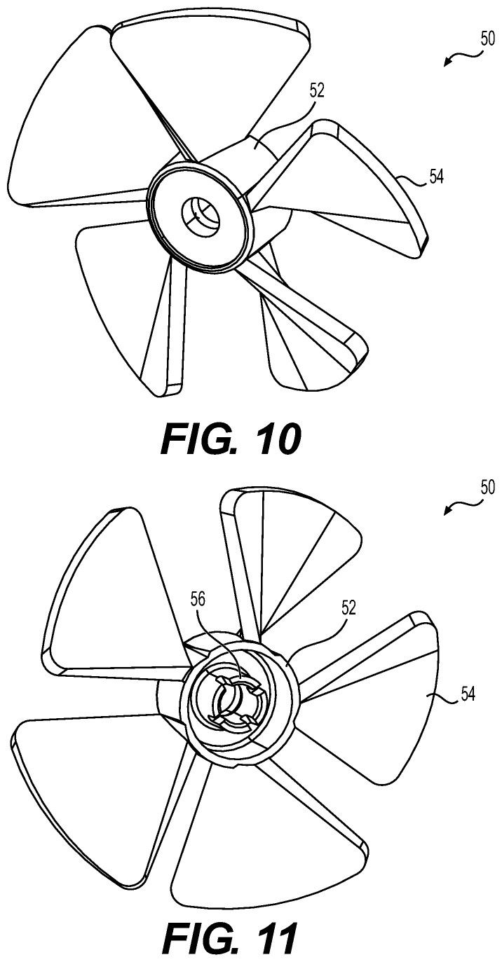

FIGS. 10 and 11 illustrate the propeller portion 50 that snaps on to the post 46 of the base portion 42. The propeller portion 50 comprises a central hub 52 and a plurality of blades 54 (five are shown) projecting therefrom. As seen in FIG. 11, a center channel 56 is defined in the central hub 52 for receiving the post 46 of the base portion 42. The enlarged distal end of the post 46 engages with a corresponding structure within the center channel 56 (typically in a snap-fit arrangement) to retain the propeller portion 50 on the post 46. When the propellor portion 50 is attached to the post 46 of the base portion 42 the propellor portion 50 is able to freely spin about the post 46. If the decorative accessory system 100B is attached to a scooter handlebar post 80 such that the system 100B is facing forward, the propellor portion 50 will typically spin when the scooter is moving forward due to the relative wind created by the forward movement of the scooter.

When attaching the spinnable propeller decorative attachment 40 to the internal base 30 (the internal base 30 already having been inserted into the external sleeve 10), the top bar of the T-shaped attachment handle 48 is inserted into the hole defined in the flexible flange 24. The decorative attachment 40 is then moved toward the internal base 30 such that the magnet 45 on the rear side of the base portion 42 contacts the ferrous plate 38 of the internal base 30, such that the magnetic attraction retains the decorative attachment 40 to the internal base 30. The engagement between the top bar of the T-shaped attachment handle 48 and the hole defined in the flexible flange 24 provides additional retention to prevent the decorative attachment 40 from falling off if the magnetic attraction is disrupted (e.g., if the scooter hits a bump that jars the decorative attachment 40).

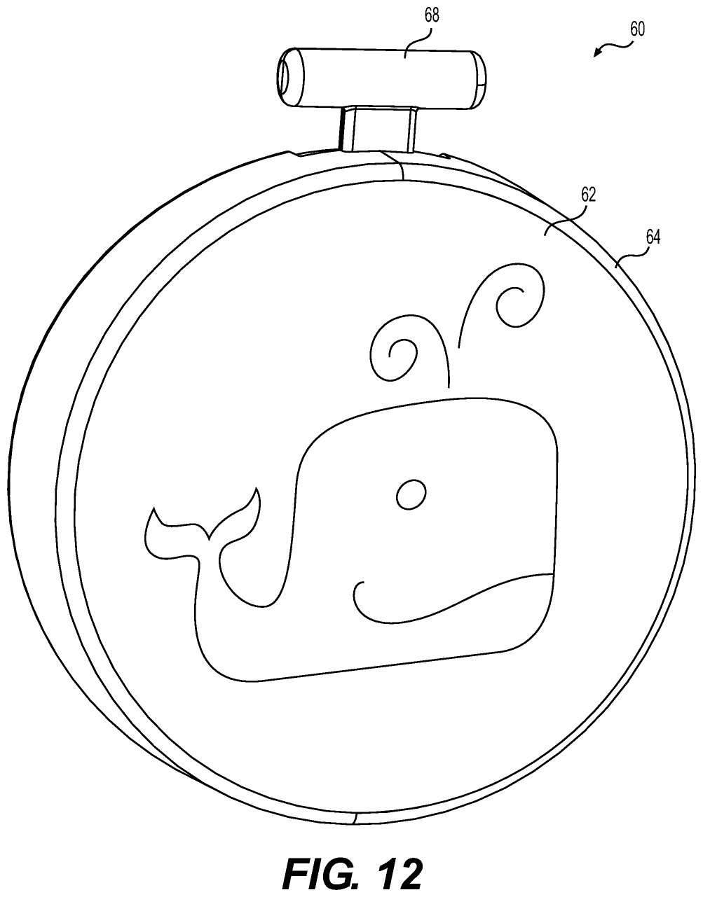

FIG. 12 illustrates one of the components that comprise the decorative image attachment 60. Specifically, FIG. 12 illustrates a base portion 64, having a generally disc-shaped main body and a T-shaped attachment handle 68 projecting upward from the main body. Although not illustrated, a ferrous plate or (more likely) a magnet is affixed to the rear side of the base portion 62 (similar to magnet 45 in FIG. 9) to selectively attach the decorative image attachment 60 to the magnet or ferrous plate 38 of the internal base 30. A decorative image portion 62 is generally disc-shaped, with a flat rear side and either a flat or domed front side. A variety of decorative images may be printed on the front side (typically under a protective transparent cover). The decorative image portion 62 is selectively attachable to the base portion 64 via a ferrous plate or (more likely) a magnet (not illustrated) affixed to the rear side of the decorative image portion 62 which cooperates with a magnet or ferrous plate (not illustrated) affixed to the front side of the main body of the base portion 64.

When attaching the decorative image attachment 60 to the internal base 30, the top bar of the T-shaped attachment handle 68 is inserted into the hole defined in the flexible flange 24. The decorative image attachment 60 is then moved toward the internal base 30 such that the magnet (not illustrated) on the rear side of the base portion 64 contacts the ferrous plate 38 of the internal base 30, such that the magnetic attraction retains the decorative image attachment 60 to the internal base 30. The engagement between the top bar of the T-shaped attachment handle 68 and the hole defined in the flexible flange 24 provides additional retention to prevent the decorative image attachment 60 from falling off if the magnetic attraction is disrupted (e.g., if the scooter hits a bump that jars the decorative image attachment 60).

As seen in FIG. 4, there are two primary ways in which a decorative accessory system of embodiments of the invention may be attached to a scooter handlebar post 80 or other similar elongated structure. In the first attachment method, a single decorative accessory system may be attached using an attachment band 70. As best seen in FIG. 3, the attachment band 70 is partially inserted through the attachment loop 20 of the external sleeve 10, and then one end loop of the attachment band 70 is passed back through the opposing end loop to secure the attachment band 70 to the attachment loop 20. The external sleeve 10 is then held against the post 80, the attachment band 70 is stretched around the post 80, and the free end of the attachment band 70 is looped around the attachment handle 36 of the internal base 30 that is projecting out of the attachment hole 22 of the external sleeve 10, as seen in FIG. 4.

In the second attachment method, three systems may be attached to each other in a string and then attached to the handlebar post 80 by forming a ring that encircles the post 80. As best seen in FIG. 1, the attachment handle 36 of one system (100A) is inserted into the attachment loop 20 of a second system (100B), then the attachment handle 36 of the second system (100B) is inserted into the attachment loop 20 of a third system (100C), thereby forming a string of three systems. The string of three systems is wrapped around the post 80 and the attachment handle 36 of the third system (100C) is inserted into the attachment loop 20 of the first system (100A), thereby forming a ring encircling the post 80.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below (if any) are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

That which is claimed:

1. A decorative accessory system comprising:
a first decorative accessory device comprising:
a rigid main body having a first side from which a T-handle or a hook extends and second side to which a ferrous plate or magnet is affixed, the second side of the main body being adjacent to the first side of the main body;
a flexible sleeve defining a chamber, the sleeve having a first side defining a first opening, a second side defining a second opening, and a third side from which an attachment loop extends, the second side of the sleeve being adjacent to both the first side and the third side of the sleeve, the third side of the sleeve being opposite the first side of the sleeve; and
a decorative element having a first side to which a magnet or a ferrous plate is affixed;
wherein the main body is selectively at least partially insertable into the chamber such that the T-handle or hook protrudes through the first opening and such that the ferrous plate or magnet of the main body is aligned with the second opening; and
wherein the decorative element is selectively attachable to the main body by contacting the magnet or ferrous plate of the decorative element to the ferrous plate or magnet of the main body.

2. The system of claim 1, wherein the sleeve has a fourth side defining a third opening through which the main body is selectively at least partially insertable into the chamber, the fourth side being opposite the second side of the sleeve and adjacent to both the first side and the third side of the sleeve.

3. The system of claim 1, further comprising a flexible band that is selectively attachable to both the T-handle or hook of the main body and to the attachment loop of the sleeve when the main body is at least partially inserted into the chamber;
wherein the flexible band is adapted to be selectively (1) attached to the attachment loop of the sleeve, (2) wrapped around an object, and (3) selectively attached to the T-handle or hook of the main body such that the main body and sleeve are secured to the object.

4. The system of claim 1, wherein the decorative element comprises a T-handle or hook extending from an edge of the decorative element;
wherein the sleeve has a flexible flange adjacent to the second opening, the flange defining a flange hole; and
wherein the T-handle or hook of the decorative element is selectively engageable with the flange hole to retain the decorative element to the main body and sleeve.

5. The system of claim 1, wherein the decorative element has a second side opposite the first side; and
wherein the decorative element has a decorative indicium attached to the second side.

6. The system of claim 1, wherein the decorative element has a second side opposite the first side; and
wherein the decorative element has an axle protruding from the second side and a free-spinning propellor mounted to the axle.

7. The system of claim 1, further comprising:
a second decorative accessory device comprising:
a rigid main body having a first side from which a T-handle or a hook extends and second side to which a ferrous plate or magnet is affixed, the second side of the main body being adjacent to the first side of the main body;
a flexible sleeve defining a chamber, the sleeve having a first side defining a first opening, a second side defining a second opening, and a third side from which an attachment loop extends, the second side of the sleeve being adjacent to both the first side and the third side of the sleeve, the third side of the sleeve being opposite the first side of the sleeve; and
a decorative element having a first side to which a magnet or a ferrous plate is affixed;
wherein the main body is selectively at least partially insertable into the chamber such that the T-handle or hook protrudes through the first opening and such that the ferrous plate or magnet of the main body is aligned with the second opening; and
wherein the decorative element is selectively attachable to the main body by contacting the magnet or ferrous plate of the decorative element to the ferrous plate or magnet of the main body.

8. The system of claim 7, wherein the second decorative accessory device is selectively attachable to the first decorative accessory device by engaging the T-handle or hook of the main body of the first decorative accessory device to the attachment loop of the sleeve of the second decorative accessory device and engaging the T-handle or hook of the main body of the second decorative accessory device to the attachment loop of the sleeve of the first decorative accessory device.

9. The system of claim 7, further comprising:
a third decorative accessory device comprising:
a rigid main body having a first side from which a T-handle or a hook extends and second side to which a ferrous plate or magnet is affixed, the second side of the main body being adjacent to the first side of the main body;
a flexible sleeve defining a chamber, the sleeve having a first side defining a first opening, a second side defining a second opening, and a third side from which an attachment loop extends, the second side of the sleeve being adjacent to both the first side and the third side of the sleeve, the third side of the sleeve being opposite the first side of the sleeve; and
a decorative element having a first side to which a magnet or a ferrous plate is affixed;
wherein the main body is selectively at least partially insertable into the chamber such that the T-handle or hook protrudes through the first opening and such that the ferrous plate or magnet of the main body is aligned with the second opening; and
wherein the decorative element is selectively attachable to the main body by contacting the magnet or ferrous plate of the decorative element to the ferrous plate or magnet of the main body.

10. The system of claim 9, wherein the first, second, and third decorative accessory devices are selectively attachable in a ring by (a) engaging the T-handle or hook of the main body of the first decorative accessory device to the attachment loop of the sleeve of the second decorative accessory device, (b) engaging the T-handle or hook of the main body of the second decorative accessory device to the attachment loop of the sleeve of the third decorative accessory device, and (c) engaging the T-handle or hook of the main body of the third decorative accessory device to the attachment loop of the sleeve of the first decorative accessory device.

11. The system of claim 10, wherein, prior to engaging the T-handle or hook of the main body of the third decorative accessory device to the attachment loop of the sleeve of the first decorative accessory device, the first, second, and third decorative accessory devices are adapted to be selectively wrapped around an object such that the first, second, and third decorative accessory devices are secured to the object when the T-handle or hook of the main body of the third decorative accessory device is engaged to the attachment loop of the sleeve of the first decorative accessory device.

12. A method for attaching decorative accessory devices to an object, the method comprising:
(a) obtaining a first decorative accessory device comprising:
a first rigid main body having a first side from which a T-handle or a hook extends and second side to which a ferrous plate or magnet is affixed, the second side of the main body being adjacent to the first side of the main body;
a first flexible sleeve defining a chamber, the sleeve having a first side defining a first opening, a second side defining a second opening, and a third side from which an attachment loop extends, the second side of the sleeve being adjacent to both the first side and the third side of the sleeve, the third side of the sleeve being opposite the first side of the sleeve; and
a first decorative element having a first side to which a magnet or a ferrous plate is affixed;
(b) at least partially inserting the first main body into the first sleeve such that the T-handle or hook of the first main body protrudes through the first opening of the first sleeve and such that the ferrous plate or magnet of the first main body is aligned with the second opening of the first sleeve;
(c) attaching the first decorative element to the first main body by contacting the magnet or ferrous plate of the first decorative element to the ferrous plate or magnet of the first main body;
(d) obtaining a second decorative accessory device comprising:
a second rigid main body having a first side from which a T-handle or a hook extends and second side to which a ferrous plate or magnet is affixed, the second side of the main body being adjacent to the first side of the main body;
a second flexible sleeve defining a chamber, the sleeve having a first side defining a first opening, a second side defining a second opening, and a third side from which an attachment loop extends, the second side of the sleeve being adjacent to both the first side and the third side of the sleeve, the third side of the sleeve being opposite the first side of the sleeve; and
a second decorative element having a first side to which a magnet or a ferrous plate is affixed;
(e) at least partially inserting the second main body into the second sleeve such that the T-handle or hook of the second main body protrudes through the first opening of the second sleeve and such that the ferrous plate or magnet of the second main body is aligned with the second opening of the second sleeve;
(f) attaching the second decorative element to the second main body by contacting the magnet or ferrous plate of the second decorative element to the ferrous plate or magnet of the second main body;
(g) obtaining a third decorative accessory device comprising:
a rigid main body having a first side from which a T-handle or a hook extends and second side to which a ferrous plate or magnet is affixed, the second side of the main body being adjacent to the first side of the main body;
a flexible sleeve defining a chamber, the sleeve having a first side defining a first opening, a second side defining a second opening, and a third side from which an attachment loop extends, the second side of the sleeve being adjacent to both the first side and the third side of the sleeve, the third side of the sleeve being opposite the first side of the sleeve; and
a decorative element having a first side to which a magnet or a ferrous plate is affixed;
(h) at least partially inserting the third main body into the third sleeve such that the T-handle or hook of the third main body protrudes through the first opening of the third sleeve and such that the ferrous plate or magnet of the third main body is aligned with the second opening of the third sleeve;
(i) attaching the third decorative element to the third main body by contacting the magnet or ferrous plate of the third decorative element to the ferrous plate or magnet of the third main body;
(j) engaging the T-handle or hook of the first main body to the attachment loop of the second sleeve to attach the second decorative accessory device to the first decorative accessory device;
(k) engaging the T-handle or hook of the second main body to the attachment loop of the third sleeve to attach the third decorative accessory device to the second decorative accessory device;
(l) wrapping the linked first, second, and third decorative accessory devices around the object; and
(m) engaging the T-handle or hook of the third main body to the attachment loop of the first sleeve to attach the first decorative accessory device to the third decorative accessory device.

13. The method of claim 12, wherein the first sleeve has a fourth side defining a third opening through which the first main body is selectively at least partially insertable into the chamber, the fourth side being opposite the second side of the first sleeve and adjacent to both the first side and the third side of the first sleeve;
wherein the second sleeve has a fourth side defining a third opening through which the second main body is selectively at least partially insertable into the chamber, the fourth side being opposite the second side of the second sleeve and adjacent to both the first side and the third side of the second sleeve; and
wherein the third sleeve has a fourth side defining a third opening through which the third main body is selectively at least partially insertable into the chamber, the fourth side being opposite the second side of the third sleeve and adjacent to both the first side and the third side of the third sleeve.

14. The method of claim 12, wherein the first decorative element comprises a T-handle or hook extending from an edge of the first decorative element;
wherein the first sleeve has a flexible flange adjacent to the second opening, the flange defining a flange hole;
wherein the T-handle or hook of the first decorative element is selectively engageable with the flange hole to retain the first decorative element to the first main body and first sleeve;
wherein the second decorative element comprises a T-handle or hook extending from an edge of the second decorative element;
wherein the second sleeve has a flexible flange adjacent to the second opening, the flange defining a flange hole;
wherein the T-handle or hook of the second decorative element is selectively engageable with the flange hole to retain the second decorative element to the second main body and second sleeve;
wherein the third decorative element comprises a T-handle or hook extending from an edge of the third decorative element;
wherein the third sleeve has a flexible flange adjacent to the second opening, the flange defining a flange hole; and
wherein the T-handle or hook of the third decorative element is selectively engageable with the flange hole to retain the third decorative element to the third main body and third sleeve.

15. The method of claim 12, wherein the first decorative element has a second side opposite the first side and a decorative indicium attached to the second side;
wherein the second decorative element has a second side opposite the first side and a decorative indicium attached to the second side; and
wherein the third decorative element has a second side opposite the first side and a decorative indicium attached to the second side.

16. The method of claim 12, wherein the first decorative element has a second side opposite the first side, an axle protruding from the second side, and a free-spinning propellor mounted to the axle;
wherein the second decorative element has a second side opposite the first side, an axle protruding from the second side, and a free-spinning propellor mounted to the axle; and
wherein the third decorative element has a second side opposite the first side, an axle protruding from the second side, and a free-spinning propellor mounted to the axle.
